(19) United States
(12) Patent Application Publication
(10) Pub. No.: US 2011/0188357 A1
(43) Pub. Date: Aug. 4, 2011

(54) LABELING A DISC WITH AN OPTICAL DISC DRIVE

(76) Inventors: Timothy Wagner, Corvallis, OR (US); Hyrum M. Anderson, Corvallis, OR (US)

(21) Appl. No.: 13/122,605

(22) PCT Filed: Oct. 6, 2008
(86) PCT No.: PCT/US08/78890

§ 371 Date: Apr. 5, 2011

(51) Int. Cl. G11B 7/007

(52) U.S. Cl. 369/44.11; G9B/7.032

(57) ABSTRACT

A system and method for labeling with a laser an optical disc having a plurality of markable locations. Signals indicative of a focus of the laser to the disc are measured, while rotating the disc at a constant angular velocity. Focus positions for designated ones of the locations to be marked on the disk are determined from the measured signals. The designated locations are marked with the laser while rotating the disc at a constant linear velocity and positioning the laser at the corresponding focus position. For at least some radial positions of the laser, an angular velocity corresponding to the constant linear velocity is less than the constant angular velocity.

### BACKGROUND OF THE INVENTION

Some optical disc drives are capable of generating a visible label on an optical disc removably inserted in the disc drive. Optical discs for use with such drives typically have, in addition to a mechanism which allows digital data to be stored on the disc, an internal or external labeling surface that includes a material whose color, contrast, or both can be changed, with the application of a laser beam thereto, to form visible markings at the positions at which the laser beam is applied. The visible markings can collectively form text, graphics, or photographic images on the optical disc. Such a labeling mechanism advantageously avoids the need for additional equipment such as a silk-screener, or for the inconvenience of printing and attaching a physical label to the disc.

When storing data to a disc, and when labeling a disc, the speed at which such operations can be completed is an important consideration for users. Thus it is advantageous for an optical disc drive to optically generate a visible label of acceptable image quality in a shorter time.

### BRIEF DESCRIPTION OF THE DRAWINGS

The features of the present invention and the manner of attaining them, and the invention itself, will be best understood by reference to the following detailed description of embodiments of the invention, taken in conjunction with the accompanying drawings, wherein:

FIG. 1 is a schematic representation of an optical disc in accordance with an embodiment of the present invention illustrated a planar labeling surface;

FIG. 2 is a schematic representation of an optical disc drive in accordance with an embodiment of the present invention;

FIG. 3 is a flowchart in accordance with an embodiment of the present invention of a method of generating visible markings on an optical disc using a laser; and

FIG. 4 is a flowchart in accordance with another embodiment of the present invention of a method of generating visible markings on an optical disc using a laser.

### DESCRIPTION OF THE PREFERRED EMBODIMENT

Referring now to the drawings, there are illustrated embodiments of an optical disc drive constructed in accordance with the present invention, and of a method of labeling an optical disc removably inserted in the disc drive in accordance with the present invention, which optically generate on the disc a visible label of a desired level of image quality in a faster manner. In order to properly focus the laser beam on the labeling surface to produce high quality markings, a z-axis focus position of the laser optical subsystem relative to the labeling surface must be properly controlled. Since an optical disc may have a warp, or may be tilted in the disc drive, the z-axis focus position may be different for different angular positions, and at different radial positions, of the disc. Thus a disc contour mapping operation is typically performed to determine the proper z-axis position at the various radial and angular positions on the disc. While the speed of disc rotation during a disc marking operation which generates the visible markings for the label on the disc is limited by the amount of energy that must be delivered by the laser onto the disc position in order to form a proper mark, the speed of disc rotation during a disc contour mapping operation is not. Accordingly, by performing the disc contour mapping operation at a faster speed of disc rotation, for a given radial position, than the speed at which the disc marking operation can be performed, the total time required to label the optical disc can be significantly reduced.

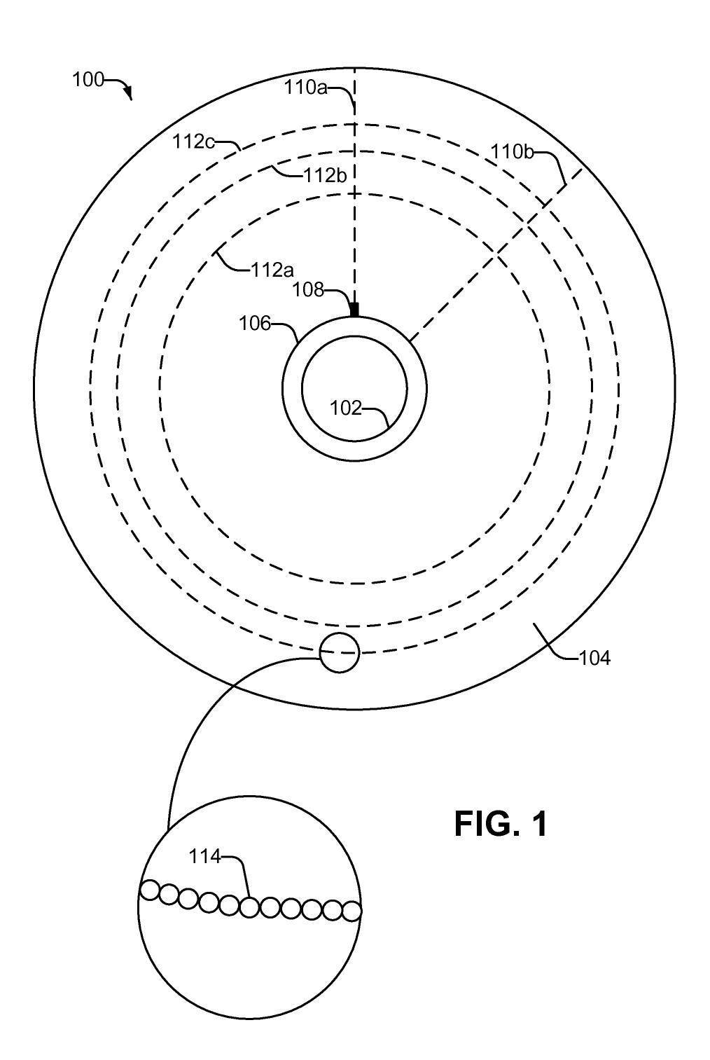

Considering now one embodiment of an optical disc, and with reference to FIG. 1, the optical disc 100 may be a CD (compact disc), DVD (digital versatile disc), or other forms of optical discs capable of forming visible markings on or in the disc in response to the application of electromagnetic energy, such as from a laser, to the disc. This includes discs in CD-R, CD-RW, DVD+R, DVD-R, DVD+RW, DVD-RW, and DVD-ROM formats, and the like. Such discs also typically store digital data that may represent, for example, photographs, videos, music, computer programs, and other various types of information or data. In some discs the data is prefabricated, while in other discs the data may be written to the disc using an optical disc drive. Digital data stored on a disc can be read from the disc using an optical disc drive.

Various physical and chemical structures may be used to provide the optical disc with the capability of forming the visible markings in response to the application of a proper amount of electromagnetic energy to the disc. In one embodiment, a labeling layer or coating is applied to at least a portion of a surface of the disc. In one embodiment, the layer is applied to the disc surface on the opposite side of the disc from the surface through which laser energy is impinged to read or write the digital data. In one embodiment, the labeling coating is a laser-sensitive layer that has thermochromic and/or photochromic materials that can be activated at desired locations by the application of laser energy to the desired locations. In some embodiments the materials may be sensitive only to energy within a particular band of frequencies, either visible or invisible. In one embodiment, these frequencies may be in the infrared or near-infrared region. When and where activated, the materials form visible markings having a particular darkness, contrast, and/or color. A coating may enable the generation of markings that are all of a single color, or multiple colors. The coating may be applied continuously to the surface, or to discrete locations on the surface.

Optical disc 100 includes a central hub 102 which mounts and positions the disc 100 in an optical disc drive for data reading and writing, and for marking a label surface 104 of the disc 100. The label surface 104 typically extends from an inner radius to an outer radius of the disc 100. In some embodiments, the inner and outer radii of the label surface 104 do not extend completely to the inner and outer radii of the disc 100. In one embodiment, a ring of disc control features 106 is disposed closer to the hub 102 than the inner radius. The disc control features 106 are usable by the disc drive to determine and control the speed of rotation of the disc 100, and the angular orientation or angular position of the disc 100 in the disc drive. In one embodiment, the disc control features 106 include an index mark 108 usable to determine a reference position for the angular position of the disc 100 in the drive. For example, angular position 110a may be defined as an angular position of 0 degrees, while angular position 110b may be defined an as angular position of approximately 45 degrees.

The laser beam generated by the optical disc drive can be positioned at a radial position between the inner radius and the outer radius of the label surface 104. While only exemplary radial positions 112a, 112b, and 112c are illustrated, it is to be understood that a large number of different radial positions 112 exist on the disc 100.

In one embodiment, locations or positions on the label surface 104 markable by the optical drive are logically organized into concentric or annular rings of individual markable locations or positions 114. Each annular ring has a corresponding radial position 112. While the exemplary markable positions 114 are illustrated as circular, within a given annular ring they may alternatively be oblong, continuous, or have other shapes. An individual markable position 114 can be marked by positioning the laser beam adjacent to the radial position of the desired markable position 114, properly focusing the laser beam on the label surface 104, and synchronizing the application of laser energy to the angular position of the disc 100 during disc rotation. In some embodiments, the concentric rings of markable positions 114 abut one another throughout the label surface 104, and thus the radial position 112 of adjacent annular rings of locations 114 may be generally determined by the dimensions of the locations 114, particularly in the radial direction.

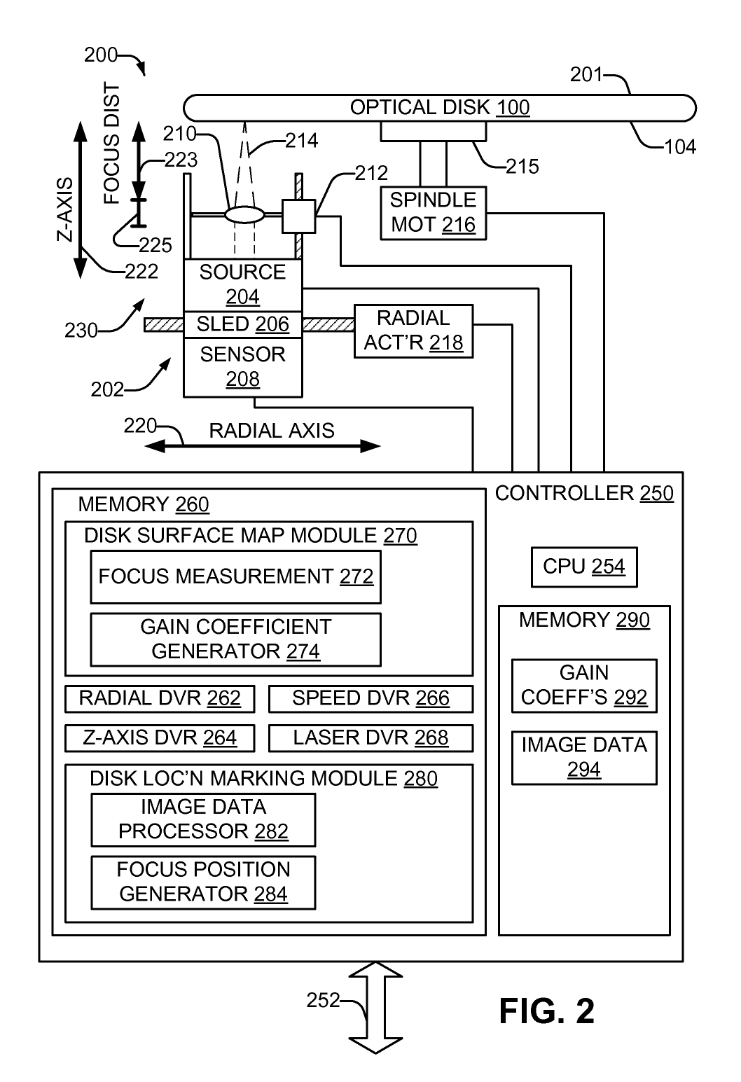

Considering now an embodiment of an optical disc drive usable to label the optical disc 100, and with reference to FIG. 2, an optical disc drive (ODD) 200 includes an optical pick-up unit assembly (OP U) 202. The OPU 202 may include an electromagnetic energy source 204, which may be a laser source, and an objective lens or focus optics 210. The OPU 200 may also include a sled 206, a sensor 208, and a focus actuator 212. The focus actuator 212 is configured to respond to an input signal, which may be voltage or current, to cause the optics 210 to move the focal point of the electromagnetic energy beam 214 generated by source 204. The electromagnetic energy beam 214 may be a laser beam. Taken together, the laser source 204 and the focus optics 210 constitute a laser 230.

In an exemplary embodiment, a spindle motor 216 is configured to spin the optical disc 100 substantially circularly past the laser 230. The optical disc 100 is removably mounted to a spindle 215 by mating the hub 102 of the disc 100 with the spindle 215. The disc 100 is mounted such that the label surface 104 faces the laser 230. Where the disc 100 is such that the label surface 104 is on (or is accessed from or through) the opposite side of the disc 100 from a data surface 201 of the disc 100, the disc 100 may be mounted in the drive 200 upside-down from the orientation used when reading digital data from, or writing digital data to, the disc 100.

A radial actuator 218 may be arranged to move the laser 230, mounted on the sled 206, to different radial positions along a radial axis 220 with respect to the center of the disc 100. The different radial positions locate the laser adjacent to corresponding radial positions on the label surface 104 such as, for example, radial positions 112a-c. The operation of the spindle motor 216 and radial actuator 218 can be coordinated to move the label surface 104 of the disc 100 and the laser 230 relative to each other to permit the laser 230 to create an image on the disc 100 by forming marks on selected ones of the markable positions 114 on the label surface 104.

In an exemplary embodiment, the focus optics 210 may mounted on lens supports and configured to travel along a z-axis 222 which is generally perpendicular to the label surface 104 of the disc 100. In an exemplary embodiment, the focus actuator 212 adjusts the focal point of the laser beam 214 by moving the focus optics 210 toward and/or away from the label surface 104 of the disc 100. In an exemplary embodiment, the focus actuator 212 is controlled during a disc marking or labeling operation to place the focus optics 210 at a desired focus position so that markings of a desired darkness, contrast, and size can be formed on desired markable positions 114 of the label surface 104.

Sensor 208 provides signal data indicative of the degree of focus of beam 214 on label surface 104. A portion of the laser energy applied to the label surface 104 can be reflected back through the optics 210 to the sensor 208. In one embodiment, sensor 208 has four individual sensor quadrants, A, B, C and D, that collectively provide a SUM signal. Quadrants A, B, C, and D may be configured to measure reflected light independent of one another. In particular, voltage is generated by the quadrants A, B, C and D in response to reflected light. When the sum of the measured voltage of the quadrants A, B, C and D are at a relative maximum, it is an indication that the focus optics 210 are positioned along the z-axis 222 in a position that places the laser beam 214 in focus on the label surface 104. In other embodiments, sensor 208 may provide different signals, such as a focus error signal (FES).

In an exemplary embodiment, the disc drive 200 includes a controller 250. The controller 250 may be connected via a computing device interface 252 to a computing device (not shown) external to the disc drive 200. The controller 250 may be implemented, in some embodiments, using hardware, software, firmware, or a combination of these technologies. Subsystems and modules, or portions thereof, of the controller 250 may be implemented using dedicated hardware, or a combination of dedicated hardware along with a computer or microprocessor controlled by firmware or software. Dedicated hardware may include discrete or integrated analog circuitry and digital circuitry such as programmable logic device and state machines. Firmware or software may define a sequence of logic operations and may be organized as modules, functions, or objects of a computer program. Firmware or software modules may be executed by at least one CPU 254 for processing computer/processor-executable instructions from various components stored in a computer-readable medium, such as memory 260. Memory 260 may be any type of computer-readable medium for use by or in connection with any computer-related system or method. Memory 260 is typically non-volatile, and may be read-only memory (ROM).

In one embodiment, the controller 250 may be implemented on one or more printed circuit boards in the disc drive 200. In other embodiments, at least a portion of the controller 250 may be located external to the disc drive 200. The disc drive 200 may be included in a computer system, such as a personal computer, may be used in a stand-alone audio or video device, may be used as a peripheral component in an audio or video system, or may be used in a stand-alone disc media labeling device or accessory. Other configurations are also contemplated.

In one embodiment, the controller 250 generates control signals for the spindle motor 216, radial actuator 218, focus actuator 212, electromagnetic energy source 204, and sensor 208. The controller 250 also reads data, where appropriate, from these components, including focus position data from sensor 208.

In some embodiments, the controller 250 includes a radial position driver 262, a z-axis position driver 264, a disc rotation speed driver 266, and a laser driver 268. In an exemplary embodiment, the drivers may be firmware and/or software components which may be stored in memory 260 and executable on CPU 254. The drivers may cause the controller 250 to selectively generate digital or analog control or data signals, and read analog or digital data signals.

In an exemplary embodiment, the disc rotation speed driver 266 drives spindle motor 216 to control a rotational speed of optical disc 100 via a spindle 215. The disc rotation speed driver 266 operates in conjunction with the radial position driver 262 which drives the radial actuator 216 to control at least coarse radial positioning of OPU assembly 202 with respect to disc 100. In disc surface contour mapping operations, and disc location marking operations, the sled 206 of OPU 202, including laser 230, is moved along the radial axis 220 to various radii positions of optical disc 100. As will be discussed subsequently in greater detail, for a given radial position of the laser 230 the disc rotation speed driver 266 rotates the disc 100, for a given radial position 112, at a faster speed during disc surface contour mapping operations than during disc location marking operations. Put another way, for a given radial position 112, disc surface contour mapping operations, which include measuring the focus distance for a particular location 114 or region of locations 114 on the disc 100, are performed at a higher angular velocity or higher linear velocity, while disc location marking operations are performed at a lower angular velocity or higher linear velocity.

In an exemplary embodiment, the laser driver 268 controls the various components of the OPU 202. The laser driver 268 controls the firing of the laser source 204, and controls the intensity of the laser beam 214 generated by the laser source 204. In some embodiments, a lower intensity laser beam 214 is generated during disc surface contour mapping operations, while a higher intensity laser beam 214 is generated during disc location marking operations, as will also be discussed subsequently in greater detail. In some embodiments, the z-axis position driver 264 also controls the focus actuator 212 in order to adjust the position along the z-axis 222 of the focus optics 210.

In an exemplary embodiment, the controller 250 may further include a disc surface contour mapping module 270, and a disc location marking module 280. The disc surface contour mapping module 270 maps the contour of the surface of the disc 100 to account for deviations, as will be discussed subsequently in greater detail, in the proper focus distance 223 for different markable locations 114 on the disc 100. In some embodiments, the disc surface contour mapping module 270 includes a focus measurement module 272 that measures signals, provided by the sensor 208, that are indicative of a degree of focus of the laser beam 214 on a given location 114 for a given position of the focus actuator 212, and a gain coefficient generator module 274 that determines gain coefficients 292 for an algorithm configured to generate the proper focus position for a given location 114. During operation, the disc surface contour mapping module 270 rotates the disc 100 at a faster speed for a given radial position 112 (i.e. a faster angular velocity or linear velocity) than does the disc location marking module 280.

The disc location marking module 280 marks designated ones of the markable locations 114 on the disc 100, according to image data 294 indicative of the labeling image to be formed on the disc 100. The image data 294 may be received via computing device interface 252 from a source external to disc drive 200, such as from a personal computer. In some embodiments, the disc location marking module 280 includes an image data processor module 282 that processes the image data 294 to determine the radial position and angular position on the disc 100 of ones of the markable locations 114 designated to be marked by the laser beam 214. In some embodiments, the image data processor module 282 may also determine, for the designated locations 114 to be marked, the darkness, contrast, and/or color of the mark. In some embodiments, the disc location marking module 280 includes a focus position generator module 284 that calculates, using the gain coefficients 292, a signal for the focus actuator 212 that positions the focus actuator 212 at the proper focus position for the radial position and the angular position of each location 114 to be marked. As the sled 206 is positioned at a designated radial position 112, and as the disc 100 is rotated by the spindle motor 216 to the designated angular position 110, the disc location marking module 280 applies to the focus actuator 212 the calculated focus position signal in sync with the rotation of the disc 100 so that the laser 230 can form the desired mark on the location 114. During operation, the disc location marking module 280 rotates the disc 100 at a slower speed for a given radial position 111 (i.e. a slower angular velocity or linear velocity) than does the disc surface contour mapping module 270.

In one exemplary embodiment, the gain coefficients 292 and the image data 294 are stored in a read-write (RAM) memory 290. In some embodiments, memory 260 and memory 290 may be the same memory device.

The operations performed by both the disc surface contour mapping module 270 and the disc location marking module 280 will be discussed subsequently in greater detail. However, before considering these in greater detail, it is useful to consider aspects of both the optical disc 100 and the optical disc drive 200 that affect the image quality of the visible markings formed on the optical disc 100 by the optical disc drive 200. It is desirable to label the disc 100 with high image quality markings as rapidly as possible. The image quality of the markings is dependent on the ability of the laser 230 to deliver to the various locations 114 on the disc 100 to be marked consistent amounts of laser energy in order to form markings that have an appropriate and consistent size, and a consistent darkness, contrast, and/or color. One factor is maintaining a consistent focus of the laser beam 214 relative to the location 114 to be marked, for all locations 114 marked. The focus must generally be maintained within a few microns of the label surface 104 of the disc 100, or the various markings may exhibit undesirable darkness, contrast, or color variations due to differences in the absorbed laser energy at the differing positions 114 on the label surface 104 of the disc 100.

However, the surface contour of discs 100 may not be flat and planar. Discs 100 can vary in thickness. In addition, they may be warped, instead of flat. Furthermore, when mounted on the spindle 215 in the disc drive 200, the disc 100 may be tilted and thus not form a plane orthogonal to the laser beam 214. The variations caused by these conditions can amount to several microns, enough to cause undesirable darkness, contrast, or color variations to occur in the markings made. Moreover, the variations in surface contour may be different at different radial positions 112 on the disc 100, and at different angular positions 110 on the disc 100. As such, if the position along the z-axis 222 of the focus optics 210 were to be kept constant during marking of the various locations 114, a consistent focus of the laser beam 214 relative to each location 114 to be written would not be maintained for all locations 114 on the disc 100 due to these disc surface contour variations, and the image quality of the label that is collectively formed by the markings would be degraded. As a result, in one embodiment the surface contour of the disc 100, which accounts for these variations, is mapped using the disc drive 200 prior to marking the locations 114 on the disc 100. The focus signals from the sensor 208 signals that are measured during the disc surface contour mapping operation are processed such that this information can subsequently be used, during a disc location marking operation, to appropriately position the laser 230 at the correct focus position along the z-axis 222 for each location's 114 radial position and angular position on the label surface 104 during marking. In this manner, markings of a consistent size, and a consistent darkness, contrast, and/or color, will be formed, resulting in a label having high quality image.

With further regard to the formation of visible markings on the disc 100 that have an appropriate and consistent size, and a consistent darkness, contrast, and/or color, the speed at which such a marking may be formed on a particular location 114 is determined partially by the characteristics of the material that forms the label surface 104, and partially by the characteristics of the laser 230. For a given type of material, to form a marking of a given size with a given darkness, contrast, and/or color, a predetermined amount of laser energy must be applied to the location 114.

The laser 230 can deliver a predetermined maximum power to the location 114. In some embodiments, the laser power used during disc location marking operations is the maximum power output of the laser 230. The maximum power is typically a function of at least the laser source 204, the focus optics 210, and the desired size of the laser beam 214 (“spot size”) produced at the location 114. In some embodiments, during a disc location marking operation, the laser 230 is intentionally defocused slightly from its optimal focus by a predetermined amount in order to produce a larger spot size. This defocusing may be accomplished, in one embodiment, by applying a focus offset signal to the focus actuator 212 that offsets the optics 210 a focus offset distance 225 along the z-axis 222 from its actual focus distance 223. In some embodiments, the focus position used during marking a location equals the focus distance 223 plus the focus offset distance 225.

Since energy=power×time, the power that can be delivered by the laser 230 to the location 114 determines the period of time (“dwell time”) that the laser 230 must dwell on the location 114 in order to properly form the marking. The required dwell time, in turn determines the rotation speed of the disc 100 applied when marking that location 114.

Thus, where the laser power is constant, in order to achieve a particular, and consistent, dwell time for the markings made at locations 114 which are at different radial positions 112 of the disc 100, the linear velocity of the disc must be the same at all radial positions 112. Linear velocity refers to the relative speed of a location 114 at a particular radial position 112 as it moves past the laser beam 214 in a tangential direction during rotation of the disc 100. The linear velocity may be measured, for example, in units of millimeters per second. To achieve the same linear velocity at all radial positions 112 on the disc 100, the disc rotation speed (i.e. the angular velocity) is varied, according to the radius being labeled, in order to maintain a constant linear velocity (CLV) during the disc location marking operation. For example, in order to maintain a CLV at label locations at a radial distance 112c further from the hub, the disc is rotated at a slower speed (i.e. a slower angular velocity) than when labeling locations at a radial distance 112a closer to the hub (i.e. at a faster angular velocity). Thus in a CLV mode of operation, the disc rotation speed, or disc angular velocity, varies based on the radial position 112 of the locations 114 being marked during the disc location marking operation.

In the disc surface contour mapping operation, however, different considerations apply. For example, only a much lower amount of laser energy is required to be delivered to the label surface 104 of the disc 100 in order to produce sufficient reflected energy that can be sensed by the sensor 208 to produce a signal indicative of the degree of focus of the laser beam 214. Thus the speed at which the disc 100 can be rotated during the mapping operation is not limited or constrained by the laser power, but rather by other system aspects. For example, in some embodiments of the disc drive 200, the disc rotation speed is limited by the response time of the control loop or loops that accurately determine the angular position of the OPU 202, the z-axis position 222 of the focus actuator 212, and the signal measurement by the sensor 208. These system considerations typically allow for significantly faster rotational speeds of the disc 100 during a disc surface contour mapping operation than during a disc location marking operation. Thus, in many embodiments, the disc surface contour mapping operation can be performed at a rotating speed which is 10 to 20 times faster than the fastest rotation speed used during a disc labeling operation.

Furthermore, the settling time associated with mechanical and electromechanical components in the disc drive 200, such as, for example, the spindle 215 and spindle motor 216, do not allow the disc rotation speed to be changed instantaneously. Rather, the speed of rotation must be ramped up or down from one speed to another. In addition, a settling time may be required to allow the new rotation speed to become consistent once it is reached. However, since the mapping operation is not limited by the laser power, in some embodiments a constant angular velocity (CAV; i.e. a constant disc rotating speed) mode can be used during the disc surface contour mapping operation. This avoids changes in disc rotation speed during mapping, which in turn avoids incurring the settling times associated with speed changes, as well as the time impact associated with slower disc rotation speeds themselves, that occur with CLV operation.

A similar settling time is associated with a change in position of the focus actuator 212, to account for movement and stabilization of the actuator 212. The focus offset distance 225 is applied during a disc marking operation, but not during a disc surface contour mapping operation. Thus these settling times would also be more frequently incurred the more often the disc drive 200 switches between a disc surface contour mapping operation and a disc location marking operation.

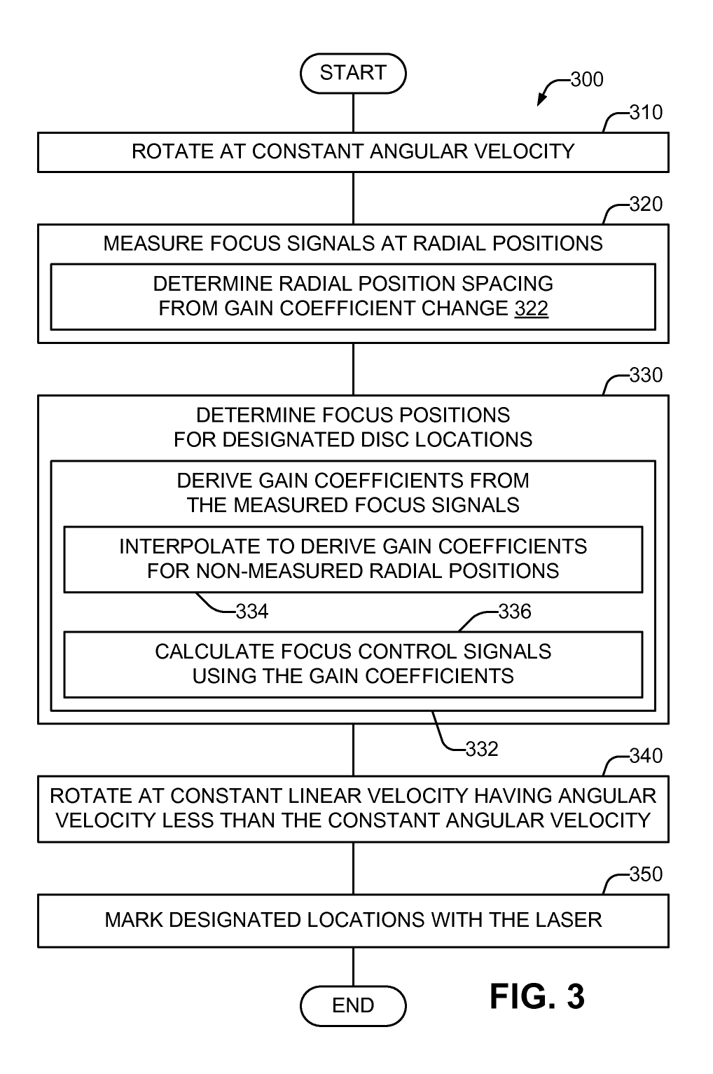

Considering now an embodiment of a method for labeling an optical disc having a plurality of markable locations with a laser, and with reference to FIG. 3, the method 300 begins at 310 by rotating a disc, such as disc 100, at a constant angular velocity for all radial positions 112. In one embodiment, a radial position 112 corresponds to a particular position along the radial axis 220 of the sled 206 which carries the laser 230 and directs the laser beam 214 onto various locations 114 at the particular radial position 112. The constant angular velocity is determined at least in part by the considerations discussed heretofore with reference to the disc surface contour mapping operation.

At 320, signals indicative of a degree of focus of the laser beam 214 on the label surface 104 of the disc 100 are measured at certain radial positions 112 of the laser 230. In some embodiments, the measurements are made using sensor 208. In embodiments where the sensor 208 is a SUM sensor, the peak value of the SUM signal generated by the sensor 208 indicates the position of the focus optics 210 in which the laser beam 214 is focused on the label surface 104. However, in some embodiments, the SUM signal reflected from label surface 104 may be noisy, and multiple measurements, signal processing techniques, or both may need to be applied to ascertain the peak value of the SUM signal. During the measurements, the control signal applied to the focus actuator 212 by the controller 250 may be varied in order to vary the position of the focus optics 210, and thus vary the degree of focus achieved. In one embodiment, the measurements may obtain the highest degree of focus, corresponding to the positioning of the focus optics 210 at the focus distance 223. In one embodiment, the measurement process may include sweeping the focus actuator 212 through a full range of focus, for each of a number of sectors of the disc 100, at each certain radial position 112. Each sector is the span defined by two adjacent angular positions 110, and the sectors are typically equally spaced around the disc 100. In one embodiment, the disc 100 has eight sectors.

Typically, the certain radial positions 112 at which the signals are measured are only a subset of all the radial positions 112 on the disc 100. In general, the signals are measured at a sufficient number of radial positions 112 to ensure that the focus positions for all locations 114, including those at non-measured radial positions 112, can be derived from the measured signals accurately enough so that the markings made on the disc 100 form a label of sufficiently high image quality. The fewer the number of different radial positions 112 at which signals are measured, the faster the disc surface contour mapping operation will be performed.

In one embodiment, the spacing between pairs of the certain radial positions 112 is constant. In one embodiment, the certain radial positions 112 at which focus distances 223 are measured are spaced 1 to 2 mm apart. The spacing distance may be chosen to ensure that the gain coefficients for locations 114 that are at nearby non-measured radial positions 112 between the current radial position 112 and the previously- or subsequently-measured radial positions 112 can be derived from the measured signals accurately enough so that the markings made on the disc 100 form a label of sufficiently high image quality.

In another embodiment, at 322, the spacing between subsequently-measured radial positions 112 is determined by the rate of change of the gain coefficients 292 between previously-measured radial positions 112. As will be discussed subsequently in greater detail, gain coefficients 292 for a radial position 112 are derived from the signals measured at that radial position 112. For example, assume that a current radial position 112 at which the signals are measured is spaced 2 mm away from the previously-measured radial position 112. Furthermore, assume that the differences in the gain coefficients 292 for the two radial positions 112 are relatively small. If so, the spacing from the current radial position 112 to the next radial position 112 at which signals are to be measured will be increased. In some embodiments, the amount of increase may be determined by the differences in the gain coefficients 292. In some embodiments, the gain coefficients 292 for the current radial position 112 may be compared to the gain coefficients 292 for more than one previously-measured radial position 112 in order to determine the spacing for the subsequently-measured radial position 112. The spacing is chosen to ensure that the focus position for locations 114 at non-measured radial positions 112 between the current radial position 112 and the subsequently-measured radial position 112 can be derived from the measured signals accurately enough so that the markings made on the disc 100 form a label of sufficiently high image quality. By increasing the spacing between measured radial positions 112, the number of signal measurements needed to fully map the contour of the label surface 104 will be reduced, and the faster the disc surface contour mapping operation will complete.

At 330, focus positions for designated locations 114 to be marked on the disc 100 at any radial position 112 of the laser 230 are determined from the measured signals. In some embodiments, the focus position is the focus distance 223 at a designation location plus the focus offset 225. Since signals are measured at only certain radial positions 112, the appropriate focus distance 223 for all locations 114, including locations 114 at radial positions 112 at which signal measurements were not performed, must be derived. In one embodiment, at 332, gain coefficients 292 usable to calculate the focus positions for the designated locations 114 to be marked are derived from the measured signals.

With regard to the gain coefficients 292, the effect on surface contour of the disc 100 being tilted on the spindle 215 can be modeled by a sinusoidal function at the frequency of rotation. In addition, the warping or bending of the disc 100 in which some positions around the disc are slightly up from nominal and the other two are slightly down from nominal can be modeled by a sinusoidal function at a higher frequency of disc rotation. Furthermore, the deviations in disc surface contour generally increase as the radial position 112 increases. Such disc surface contour characteristics may be modeled, in one embodiment, using a Fourier expansion of sine and cosine functions. In an embodiment of disc warpage in which two opposing sides of the disc 100 are slightly up from nominal and the other two are slightly down from nominal, and in which the surface contour can be modeled by a sinusoidal function at twice the frequency of disc rotation, five terms are required for the Fourier expansion: sine and cosine of the fundamental frequency, sine and cosine of the second order frequency, and a DC term. Each of the five terms has a gain coefficient. In one embodiment the five gain coefficients 292 are calculated, using the measured signals, for each of the radial positions 112 at which the signals are measured. The gain coefficients 292 may be stored in the memory 290 of the disc drive 200. At least one embodiment of a technique usable to calculate the gain coefficients 292 is described in U.S. Pat. No. 7,177,246, “Optical Disk Drive Focusing Apparatus Using SUM Signal”, by Hanks et al., and assigned to the assignee of the present invention.

In some embodiments, at 336, control signals for setting the focus positions for the designated locations to be marked are calculated by using the gain coefficients 292 in a Fourier series algorithm. The algorithm is configured to use the gain coefficients 292 and the angular position 110 of disc rotation with respect to the laser 230 to generate a control signal for the focus actuator 212 that places the optics 210 at the desired focus position, as the disc 100 rotates. At least one embodiment of an algorithm usable to generate the actuator control signal is also described in U.S. Pat. No. 7,177,246, referenced above. The actuator control signal, at any radial position 112, may be generated using the gain coefficients for that radial position 112 according to the following formula:

Actuator control signal=(A0*DC0)+(A1*QS1)+(B1*QC1)+(A2*QS2)+(B2*QC2)

In one embodiment QS1 and QC2, for example, are the sine and cosine values, respectively, for the given value of an angular position of disc rotation theta and two times theta, respectively, for the first and second harmonic, respectively. In one embodiment DC0 is a nominal signal level that results in approximate focusing of the laser beam 214 on the label surface 104 of the disc 100. The five gain coefficients are denoted as A0, A1, A2, B1, and B2.

In some embodiments, at 334, the gain coefficients 292 for two adjacent measured radial positions are interpolated to derive the gain coefficients 292 for a non-measured radial position that is in-between the two adjacent radial positions. For example, the gain coefficients 292 for radial positions 112a and 112c can be interpolated to derive gain coefficients for radial position 112b. The interpolated gain coefficients are then used by the fourier series algorithm.

At 340, the disc, such as disc 100, is rotated at a constant linear velocity. At a given radial position 112 of the laser 230, the constant linear velocity used during the disc location marking operation corresponds to an angular velocity that is less than the constant angular velocity used during the disc surface contour mapping operation. The constant linear velocity is determined at least in part by the power output from the laser 230 and related considerations discussed heretofore with reference to the disc location marking operation. In some embodiments, the constant linear velocity used during the disc location marking operation corresponds to an angular velocity that is less than the constant angular velocity used during the disc surface contour mapping operation at all radial positions 112 of the laser 230.

At 350, the designated locations are marked by the laser 230 while the laser 230 is positioned at the focus position which corresponds to each designated location 114 being marked. The focus position is established by the focus optics 210 in response to the control signal for the focus actuator 212 that is generated in synchronization with the rotation of the disc 100.

In some embodiments, signals are measured for all of the radial positions 112 on the disc 100 that are to be measured, before any of the designated locations 114 on the disc 100 are marked by the laser 230. For some similar reasons as those explained heretofore with regard to mechanical and electromechanical constraints and settling times of the disc drive 200, such operation reduces the total time needed to perform the disc surface contour mapping operation and the disc location marking operation, by performing the mapping operation at a faster rotating speed than the marking operation for a given radial position 112, by reducing the number of changes in rotating speed of the disc 100, and by reducing changes to the settings of the focus actuator 212. Such time savings can be significant. For example, if a disc 100 has a label region that spans about 35 mm, but if signals are measured in the disc surface contour mapping operation for a radial span of only about 2 mm at a time, then about 36 transitions or interleaves between the disc surface contour mapping operation and the disc location marking operation will occur, incurring significant penalties in the total time required to label the disc 100. In such situations, the overhead incurred can erode or eliminate the performance advantages that can be gained by mapping at a faster speed than marking, and may lead to design decisions to perform mapping at the same speed as marking.

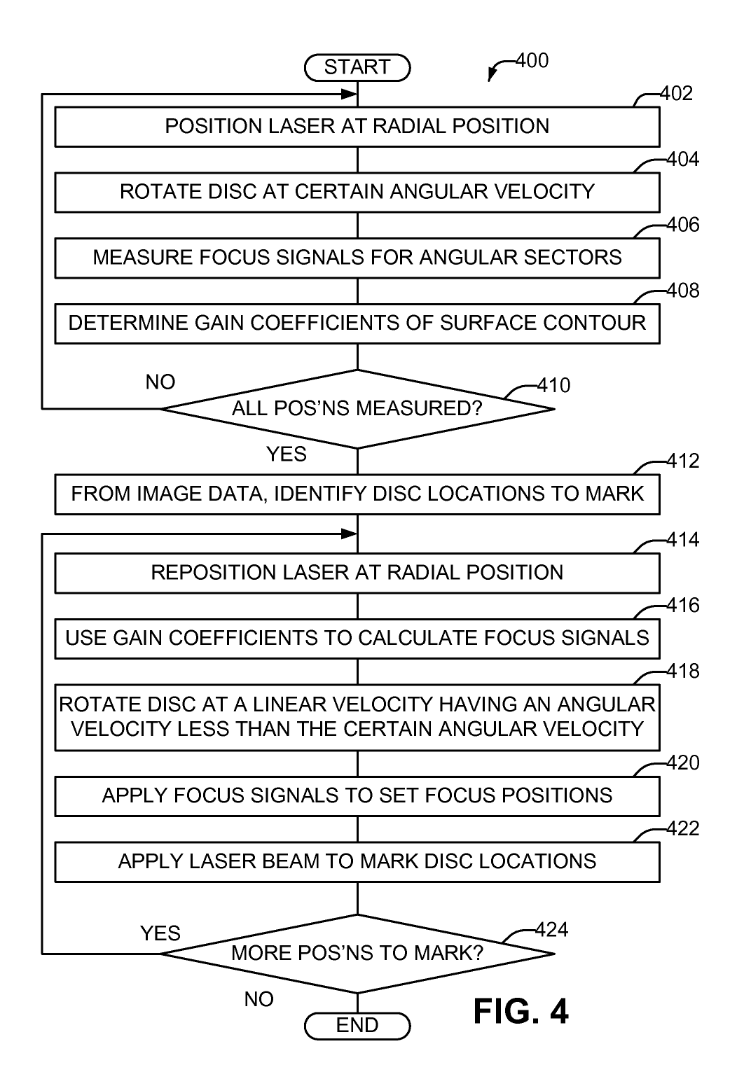

Considering now an embodiment of a method for generating visible markings on an optical disc using a laser, and with reference to FIG. 4, the method 400 begins at 402 by positioning a laser, such as laser 230 of disc drive 200, at a radial position 112 with respect to the disc 100. In some embodiments, the initial radial position 112 is the innermost or outermost radial position of the label surface 104. At 404, the disc 100 is rotated at a certain angular velocity. The certain angular velocity is determined at least in part by the considerations discussed heretofore with reference to the disc surface contour mapping operation.

At 406, signals indicative of a degree of focus of the laser 230 on the label surface 104 is measured for different angular sectors of the radial position 112. A sector may be understood as an angular span of the disc 100 between two angular positions 110. At 408, gain coefficients 292 indicative of a surface contour of the disc 100 at the radial position 112 are determined from the measured signals.

As has been explained heretofore with reference to FIG. 3, signal measurements and gain coefficient determinations may be performed at a number of different radial positions 112, with the different radial positions 112 typically being spaced apart from each other. If all radial positions 112 have not been measured (“No” branch of 410), the location of the next radial position 112 to be measured is determined and the method branches back to 402 to position the laser 230 at that next radial position 112. In some embodiments, as explained heretofore with reference to FIG. 3, the next radial position 112 may be a predefined radial distance away from the current radial position 112. In other embodiments the radial spacing distance for subsequently-measured radial positions 112 may be determined based on the gain coefficients 292 that have already been determined for prior radial positions 112.

Once all radial positions 112 have been measured (“Yes” branch of 410), the method continues, at 412, by processing image data, such as image data 294 received by disc drive 200, to identify the angular position 110 and radial position 112 of locations 114 on the disc 100 that are to be marked by the laser 230.

At 414, the laser 230 is repositioned at a radial position 112 at which at least some locations 114 are to be marked. The radial position is determined from the processing 412, and the first radial position 112 is typically the innermost or outermost radial position of the label surface 104 at which at least some locations 114 are to be marked. At 416, control signal values usable to set the focus actuator 212 to focus positions of the laser 230 at the angular positions of the current radial position 112 are calculated using the gain coefficients 292. For the radial position 112 of at least some of the locations 114 to be marked, it is likely that signals were not measured at step 406 for that position 112. Thus, in some embodiments, the gain coefficients 292 for two adjacent measured radial positions 112a,c are interpolated to derive the gain coefficients 292 for a non-measured radial position 112b that is in-between the two adjacent radial positions 112a,c. In other embodiments, the gain coefficients 292 for the nearest measured radial position 112c are used as the gain coefficients 292 for a nearby non-measured radial position 112b. The gain coefficients 292 for the current radial position 112 are used by a Fourier series algorithm, which may be performed by focus position generator 284 in the disc drive 200, to calculate the control signal values in a similar manner as described heretofore.

At 418, the disc is rotated at a certain linear velocity that, at the current radial position 112, has a corresponding angular velocity which is less than the certain angular velocity of step 404. The certain linear velocity is determined at least in part by the power output from the laser 230 and related considerations discussed heretofore with reference to the disc location marking operation. The certain linear velocity is typically constant at all radial positions 112 of the disc 100 in order to achieve uniform markings at all locations 114 on the disc 100.

At 420, in sync with the rotation of the disc 100, the signals calculated at step 416 are applied to the focus actuator 212 to set the focus positions for the current angular position 110 of the disc 100. At 422, and also in sync with the rotation of the disc 100, the laser beam 214 is applied at the angular positions 110 of the locations 114 to be marked, in order to optically mark these locations.

If locations 114 at more radial positions 112 still remain to be marked (“Yes” branch of 424), the location of the next radial position 112 which has locations 114 to be marked is determined, and the method branches back to 414 to position the laser 230 at that next radial position 112. By determining the next radial position 112 having locations 114 to be marked, totally blank (unmarked) radial positions 112 can be skipped over, resulting in faster operation. Once all radial positions 112 have been marked (“No” branch of 424), the method concludes.

In one embodiment, steps 402-410 may be considered to be part of a disc surface contour mapping operation, while steps 414-424 may be considered to be part of a disc location marking operation.

From the foregoing it will be appreciated that the optical disc drive and methods provided by the present invention represent a significant advance in the art. Although several specific embodiments of the invention have been described and illustrated, the invention is not limited to the specific methods, forms, or arrangements of parts so described and illustrated. For example, the invention is not limited to an optical disc drive. Rather, the invention also applies to other devices which mark optically-labelable material having a varying surface contour, regardless whether the motion between the labelable material and the source of electromagnetic energy is rotational or translational. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Unless otherwise specified, steps of a method claim need not be performed in the order specified. The invention is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements. Terms of orientation and relative position (such as “top”, “bottom”, “side”, and the like) are not intended to require a particular orientation of embodiments of the present invention, or of any element or assembly of embodiments of the present invention, and are used only for convenience of illustration and description.

What is claimed is:

1. A method of labeling with a laser an optical disc having a plurality of markable locations, comprising:
measuring signals indicative of a focus of the laser to the disc, while rotating the disc at a constant angular velocity;
determining, from the measured signals, focus positions for designated ones of the locations to be marked on the disc; and
marking the designated locations with the laser while rotating the disc at a constant linear velocity and positioning the laser at the corresponding focus position, wherein, for at least some radial positions of the laser, an angular velocity corresponding to the constant linear velocity is less than the constant angular velocity.

2. The method of claim 1, wherein all the signals are measured before any of the designated locations are marked.

3. The method of claim 1, wherein the laser has a predefined laser power, and wherein the constant linear velocity is sufficient for the laser to deliver sufficient energy to the designated locations to form markings having a predetermined size and contrast.

4. The method of claim 3, wherein the constant angular velocity is not determined by the predefined laser power.

5. The method of claim 1, wherein an optical drive comprises the laser, and wherein the constant angular velocity is determined by components of the optical drive other than the laser.

6. The method of claim 1, wherein the signals are measured at certain radial positions of the laser, and at least some of the designated locations are located at other radial positions of the laser.

7. The method of claim 1, wherein the signals are measured at spaced-apart radial positions of the laser, and wherein the spacing between at least some subsequently-measured ones of the radial positions is determined by the rate of change of gain coefficients between at least some previously-measured ones of the radial positions, wherein the gain coefficients are derived from the measured signals and usable to set the focus positions for the designated locations.

8. The method of claim 1, wherein the determining comprises:
calculating control signals for setting the focus positions for the designated locations by using gain coefficients derived from the measured signals in a Fourier series algorithm.

9. The method of claim 1, wherein the signals are measured at spaced-apart radial positions of the laser, and wherein the determining comprises:
interpolating between gain coefficients derived from the measured signals for two adjacent radial positions to derive the gain coefficient for a radial position in-between the two adjacent radial positions.

10. An optical drive, comprising:
a motor operable to rotate an optically-labelable disc disposed in the drive;
a laser operable to visibly mark a label surface of the disc;
a radial actuator operable to position the laser adjacent a radial position of the label surface;
a focus actuator operable to position the laser a distance from the label surface;
a controller configured, for a given radial position, to operate the motor at a first speed during a focus distance measuring operation, and to operate the motor at a second speed slower than the first speed during a disc labeling operation.

11. The optical drive of claim 10 wherein, during the focus distance measuring operation, the controller operates the radial actuator to position the laser at certain radial positions, adjusts the focus actuator, and measures, from a sensor, signals indicative of a focus of the laser at the certain radial positions.

12. The optical drive of claim 10, wherein the controller derives, from measured signals indicative of a focus of the laser, gain coefficients usable to calculate focus positions for designated markable locations on the disc.

13. The optical drive of claim 12, wherein different gain coefficients for each of a plurality of different radial positions are simultaneously stored in a memory.

14. The optical drive of claim 12, wherein the measured signals correspond to spaced-apart radial positions, and wherein the spacing between at least some later-measured ones of the radial positions is determined by the rate of change of the gain coefficients between at least some earlier-measured ones of the radial positions.

15. The optical drive of claim 12, wherein, during the disc labeling operation, the controller processes image data to determine locations on the optically-labelable disc to be optically marked, associates each location with a radial position and an angular position on the label surface, and calculates using the gain coefficients the focus position associated with the radial position and the angular position of each location.

16. The optical drive of claim 10, wherein, during the disc labeling operation, the controller
operates the motor and the radial actuator to position the laser adjacent each location on the label surface to be marked,
operates the focus actuator to position the laser at a focus position associated with each location, and
operates the laser to form a marking having a predetermined size and contrast at each location.

17. A method of optically generating visible markings on an optical disc, comprising:
positioning a laser at a radial mapping position with respect to the disc;
while rotating the disc at a certain angular velocity, measuring signals indicative of a focus of the laser at the radial mapping position;
determining from the measured signals gain coefficients indicative of a contour of the disc at the radial mapping position;
repositioning the laser at a radial marking position of a location to be marked on the disc;
using the gain coefficients, calculating a focus position for the location;
while rotating the disc at a certain linear velocity that, at the radial marking position, corresponds to an angular velocity less than the certain angular velocity, and synchronized with an angular marking position of the location,
operating a focus actuator to set the focus position for the location, and
applying energy from the laser to the location to optically mark the location.

18. The method of claim 17, wherein the location to be marked is a plurality of locations each having a radial marking position and an angular marking position, the method further comprising:
repeating the positioning, measuring, and determining at different radial mapping positions until the gain coefficients are determined for all radial mapping positions; and
repeating the repositioning, calculating, operating, and applying at different radial marking positions until all of the plurality of locations are marked.

19. The method of claim 18, comprising:
processing image data to identify the angular marking position and radial marking position for the plurality of locations on the disc to be optically marked.

20. The method of claim 18, wherein the different radial mapping positions are spaced apart, and wherein the spacing between at least some later-measured radial mapping positions is determined by the rate of change of the gain coefficients between at least some previously-measured radial mapping positions.
